(19) United States
(12) Patent Application Publication
(10) Pub. No.: US 2013/0277187 A1
(43) Pub. Date: Oct. 24, 2013

(54) BUTTON DEVICE WITH WATERPROOF FUNCTION AND ELECTRONIC DEVICE HAVING THE SAME

(71) Applicants: Hou-Chun Huang, New Taipei City (TW); Chih-Feng Yeh, New Taipei City (TW)

(72) Inventors: Hou-Chun Huang, New Taipei City (TW); Chih-Feng Yeh, New Taipei City (TW)

(21) Appl. No.: 13/544,678

(22) Filed: Jul. 9, 2012

(30) Foreign Application Priority Data
Apr. 20, 2012 (TW) 101114175

(51) Int. Cl. H01H 13/06

(52) U.S. Cl. 200/302.2

(57) ABSTRACT

A button device with waterproof function is disclosed. The button device is mounted on an electronic device. The button device includes a push button and a sealing member, wherein the sealing member includes a fixed element and a trigger connected to the fixed element. The trigger includes an inner ring and an outer ring. The outer ring is placed around the inner ring, and a partitioned groove is formed between the inner ring and the outer ring.

### BACKGROUND OF THE INVENTION

1. Field of the Invention

The invention herein relates to a button device that has waterproof function, especially a button device that prevents the waterproof ring from coming off owing to the pressing on the button device.

2. Prior Art

Please refer to FIG. 1, which is a button device 1c, and is known for having waterproof function. The button device 1c is disposed at an electronic device 90, which comprises a push button 10c and a sealing member 20c, wherein the sealing member 20c comprises a fixed element 22c and a trigger 21c, which has a waterproof ring 2131c. The fixed element 22c enables the sealing member 20c to be fixed on the cover 91 of the electronic device 90. The trigger 21c is used to touch the button 92 when the push button 10c is pressed with external force, so that the button 92 produces an electric signal transmitted to the central processor or control device through circuit board 93 (not shown in figures).

Under normal circumstances, the waterproof ring 2131c is anchored in the ring-shaped groove 912 of the cover 91, so that the waterproof function is secured through the combined interference through the two when external moisture is blocked from entering through the installation hole. However, when a user presses the push button 10c inwardly, the force created by the user's pressing affects the waterproof ring 2231c owing to the fact that the sealing member 20c is of an integral solid structure. It causes the waterproof ring 2121a to break away from the ring-shaped groove 912 when a user repeatedly presses the button device 1c for a significant period of time (as shown with arrow F1 in FIG. 1). Once the waterproof ring 2121a breaks away from the ring-shaped groove 912 and is no longer capable of providing intimate interference with the cover 91, external moisture will seep through the gap of the installation hole(as shown with arrow F2 in FIG. 1), and thus causes the failure of the waterproof button device 1c.

Therefore, there is a definitive need to invent a new button device to resolve the problems addressed above.

### SUMMARY OF THE INVENTION

The main purpose of the present invention is to provide a button device with waterproof function.

The other main purpose of the present invention is to provide an electronic device with the button device stated above.

To achieve the purpose stated above, the button device with waterproof function in the present invention is disposed at the electronic device. The electronic device comprises a cover, which includes an installation hole and a ring-shaped groove. The button device with waterproof function comprises a push button and a sealing member, wherein the sealing member comprises a trigger, which comprises a inner ring and a outer ring, wherein the outer ring is placed around the inner ring, and a partitioned groove is formed between the inner ring and the outer ring; the outer ring comprises a waterproof ring, which is used to be anchored in the ring-shaped groove.

In order to achieve the other purpose stated above, the electronic device comprises a cover and the button device with waterproof function stated above, wherein the cover comprises an installation hole and a ring-shaped groove, and the button device stated above is disposed at the installation hole.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 is the illustration of the button device in prior art.

FIG. 2 is the breakdown illustration of the electronic device in the present invention.

FIG. 3 is the breakdown illustration of the button device in the present invention.

FIG. 4 is the illustration of the partial cross-section of the button device in the present invention.

FIG. 5 is the illustration of the partial profile view of the button device disposed at the electronic device in the present invention.

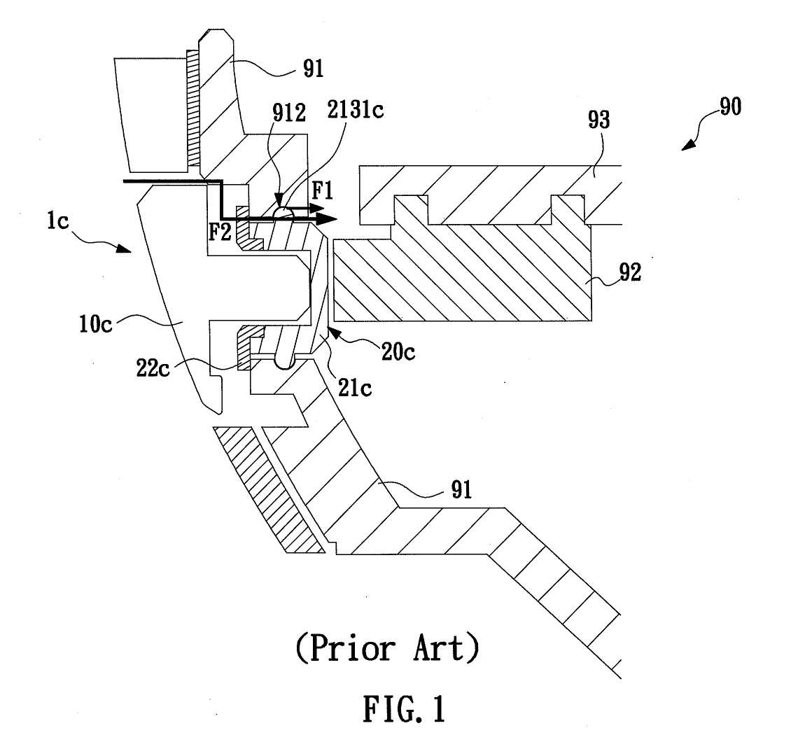

### DETAILED DESCRIPTION OF THE PREFERRED EMBODIMENTS

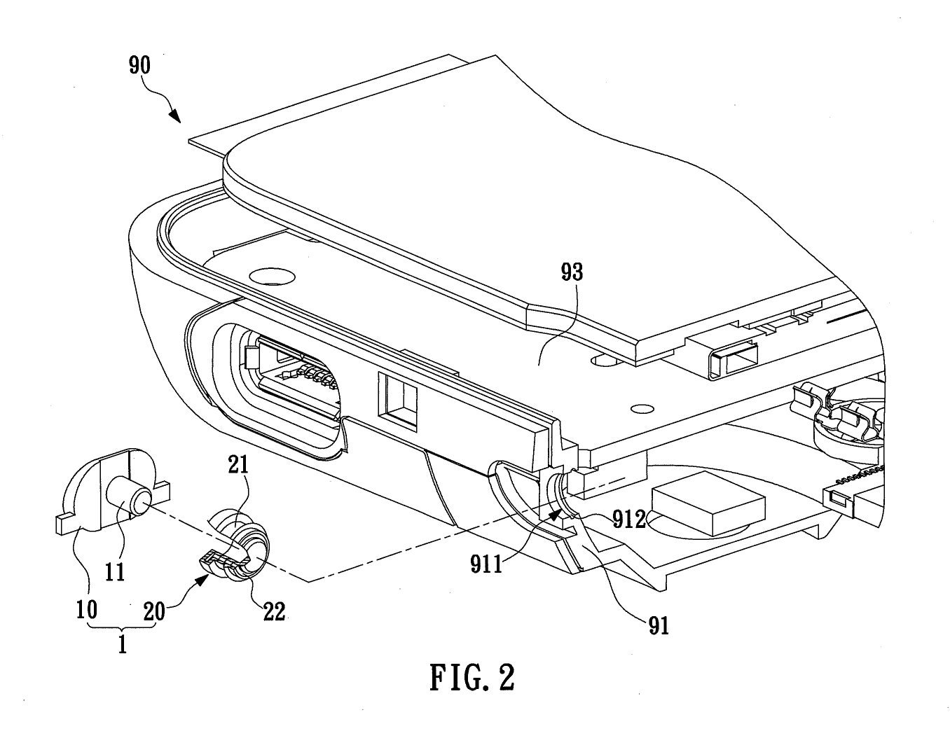

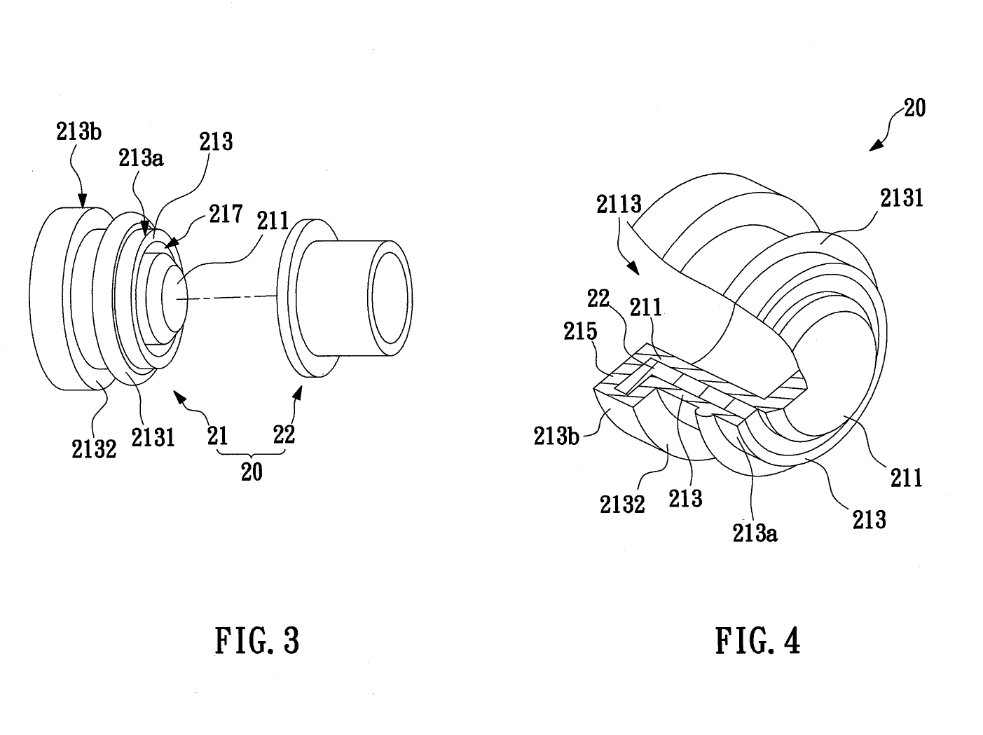

Please refer to FIG. 2 to FIG. 4 altogether. Among them, FIG. 2 is the breakdown illustration of the electronic device in the present invention. FIG. 3 is the breakdown illustration of the button device in the present invention. FIG. 4 is the illustration of the partial cross-section of the button device in the present invention.

As shown in FIG. 2, in one of the embodiments of the present invention, the button device 1 with waterproof function in the present invention is applied to an electronic device 90. The electronic device 90 comprises a cover 91, which comprises an installation hole 911 and a ring-shaped groove 912. And the button device 1 is disposed in the installation hole 911. In the embodiments of the present invention, the electronic device 90 is a smart mobile phone, and the installation hole 911 is a sideway hole installed on the side of the cover 91. The button device 1 is a sideway button, yet the button device 1 in the present invention is not limited to a sideway button.

In one of the embodiments of the present invention, the button device 1 comprises a push button 10 and a sealing member 20, wherein the push button 10 comprises a convex axis 11, and the sealing member 20 comprises a trigger 21 and a fixed element 22.

As shown in FIGS. 2, 3, and 4, in one of the embodiments of the present invention, the trigger 21 is made of rubber material, and it comprises an inner ring 211, an outer ring 213, and a bottom 215.

The outer ring 211 is in a hollow cylinder shape, and at one end of it, a concave hole 2113 is formed. The concave hole 2113 is used to hold and connect with the convex axis 11 so that the push button 10 is connected with the sealing member 20.

The outer ring 213 is disposed around the inner ring 211, and a partitioned groove 217 is formed between the inner ring 211 and the outer ring 213. In one of the embodiments of the present invention, the partitioned groove 217 is in an L shape while the sealing member 20 is displayed with its cross-section view, and its width is virtually between 0.1 and 0.2 mm. The outer ring 213 comprises a frontal part 213a and a rear part 213b, wherein a waterproof ring 2131 is disposed at the frontal part 213a. The waterproof ring 2131 is anchored in the ring-shaped groove 912 of the cover 91 to prevent moisture from seeping through the installation hole 911 with the intimate interference of the two. The girth of the rear part 213b is greater than that of the frontal part 213a, therefore the rear part that sticks out from the frontal part forms the retaining part 2132, which is anchored around the installation hole 911 to prevent the button device 1 from slipping into the installation hole 911.

In one of the embodiments of the present invention, the shape of the fixed element 22 is a hollow cylinder, and the fixed element 22 is disposed in the partitioned groove 217. The volume of the fixed element 22 is virtually equal to the capacity of the partitioned groove 217. The fixed element 22 is used to support the trigger 21 to strengthen the entirety of the structure of the sealing member 20. In the embodiments of the present invention, the fixed element 22 is incorporated with the trigger 21 through hot pressing, yet the present invention is not limited to it. If there is sufficient hardness in the trigger 21, it is doable to incorporate the trigger 21 and the fixed element 22 into one single unit. In the embodiments of the present invention, the fixed element 22 is a metal piece, yet the present invention is not limited to it.

The bottom 215 is connected with one bottom of the inner ring 211 and the outer ring 213.

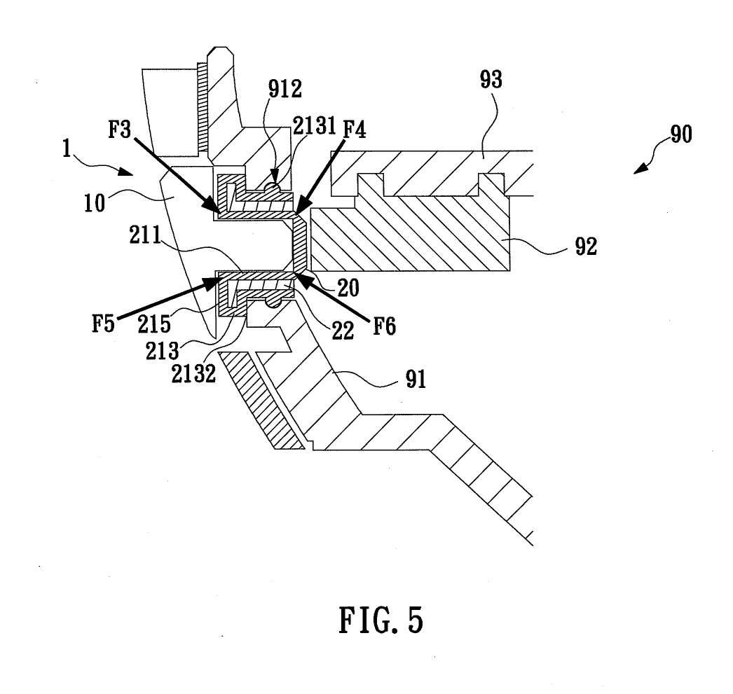

Please refer to FIG. 5, which relates to the partial cross-section view of the button device of the present invention when the button device is disposed at the electronic device.

As shown in FIG. 5, which is a profile view of the button device 1 with waterproof function, disposed at the installation hole 911 in the present invention. When a user presses the push button 10, the force created by the pressing is only functioning on the inner ring 21 (as indicated by the arrows F4, F5, F6 and F7 in FIG. 5) because of the fact that there is the partitioned groove 217 between the inner ring 211 and the outer ring 213 for the sealing member 20 of the button device 1 in the present invention. It is unlike the traditional button device which is of a solid structure. Therefore the outer ring 213 will not be affected. Thus, for the waterproof ring 2131, it will not be greatly affected by the pressing of a user. Thus, even though the button device 1 has been through frequent pressing by users, the waterproof ring 2131 will not break away from the ring-shaped groove 912; long term waterproof effect can be achieved; the defect of prior art can be improved.

It is worth noting that the embodiments stated above only exemplify better embodiments in the present invention. To avoid redundant statements, detailed record of all possible variations is not provided. Yet this is understandable to those with general knowledge in this field. The elements stated above are not all necessary. Also to implement the present invention, it is possible to include elements with further details. The elements can be omitted or altered according to needs. And it is not impossible for the existence of other elements between any two elements. For example, if the trigger 21 is made of rubber that has high hardness, the fixed element 22 can be left out.

It is noted that the above-mentioned embodiments are only for illustration. It is intended that the present invention cover modifications and variations of present invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A button device with waterproof function, which is disposed at an electronic device that comprises a cover which comprises an installation hole and a ring-shaped groove, comprising:
a push button; and
a sealing member, which comprises a trigger that comprises:
an inner ring, which is connected with the push button; and
an outer ring, which is placed around the inner ring, and
a partitioned groove is formed between the inner ring and the outer ring, wherein the outer ring comprises a waterproof ring which is used to be anchored in the ring-shaped groove.

2. The button device with waterproof function of claim 1, wherein the sealing member further comprises a fixed element, which is disposed in the partitioned groove.

3. The button device with waterproof function of claim 2, wherein the outer ring comprises a retaining part, which is used to stabilize the sealing member at the installation hole.

4. The button device with waterproof function of claim 3, wherein the partitioning groove is in an L-shape at the profile of the sealing member.

5. The button device with waterproof function of claim 4, wherein the volume of the fixed element is equal to the capacity of the partitioned groove.

6. The button device with waterproof function of claim 5, wherein the width of the partitioned groove is W millimeter, wherein 0.1≦W≦0.2.

7. An electronic device, comprising:
a cover, comprising an installation hole and a ring-shaped groove: and
a button device with waterproof function, comprising:
a push button; and
a sealing member, comprising a trigger, which comprises:
an inner ring, which is connected with the push button; and
an outer ring, which is placed around the inner ring, and a partitioned groove is formed between the inner ring and the outer ring, wherein the outer ring comprises a waterproof ring which is used to be anchored in the ring-shaped groove.

8. The electronic device of claim 7, wherein the sealing member further comprises a fixed element, which is disposed in the partitioned groove.

9. The electronic device of claim 8, wherein the outer ring comprises a retaining part, which is used to stabilize the sealing member in the installation hole.

10. The electronic device of claim 9, wherein the partitioned groove is in an L-shape at the profile of the sealing member.

11. The electronic device of claim 10, wherein the volume of the fixed element is equal to the capacity of the partitioned groove.

12. The electronic device of claim 11, wherein the width of the partitioned groove is W millimeter, wherein 0.1≦W≦0.2.
